(19) United States
(12) Patent Application Publication
(10) Pub. No.: US 2004/0184400 A1
(43) Pub. Date: Sep. 23, 2004

(54) Multicarrier transmitter, multicarrier receiver, and multicarrier communications apparatus

(76) Inventors: Hisao Koga, Chikushi-gun (JP); Nobutaka Kodama, Fukuoka-shi (JP); Taisuke Konishi, Kasuga-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/719,061

(22) Filed: Nov. 24, 2003

(30) Foreign Application Priority Data
Nov. 25, 2002 (JP) P. 2002-340586

(51) Int. Cl. H04J 11/00

(52) U.S. Cl. 370/208

(57) ABSTRACT

The present invention aims at providing a multicarrier transmitter capable of processing complex information as send data. A multicarrier transmitter according to the invention includes: a signal point mapping unit 105 for performing symbol mapping of a series of information; a serial-to-parallel converter 106 for converting serial data as the symbol mapped series of information to parallel data; a first inverse wavelet transformer 102 including a plurality of real coefficient wavelet filters orthogonal to each other; the first inverse wavelet transformer performing a first wavelet transform on the parallel data; a second inverse wavelet transformer 103 including real coefficient wavelet filters different from those of the transformer 102; the second inverse wavelet transformer performing a first wavelet transform on the parallel data; and a modulator 107 for performing SSB modulation by using the output from the transformer 102 as an in-phase signal of complex information and the output from the transformer 103 as an orthogonal signal of complex information.

### BACKGROUND OF THE INVENTION

1. Field of the Invention

The present invention relates to a multicarrier transmitter (DWMC transmitter or Digital Wavelet Multi Carrier Transmitter) for performing data transmission by way of digital modulation using a real coefficient wavelet filter bank, a multicarrier receiver (DWMC receiver) for performing data reception by way of digital demodulation using a real coefficient wavelet filter bank, and multicarrier communications apparatus (DWMC communications apparatus) for performing data communications by way of digital modulation/demodulation using a real coefficient wavelet filter bank.

2. Description of Conventional Art

Communications apparatus for performing digital modulation/demodulation using a real coefficient wavelet filter bank is communications apparatus which is based on a multicarrier modulation system. Such communications apparatus synthesizes a plurality of digital modulated waves to generate a send signal by way of a real coefficient wavelet filter bank. The apparatus uses the pulse-amplitude modulation (PAM) to modulate each subcarrier.

FIG. 17 is a graph showing the impulse responses of each subcarrier in DWMC communications apparatus. FIG. 18 is a waveform diagram showing a waveform where the impulse responses of the subcarriers are synthesized. As shown in FIG. 17, data transmission by way of DWMC communications apparatus is made while impulse responses of each subcarrier are overlapped on each other. As shown in FIG. 18, each transmission symbol is represented as a waveform where the impulse responses of the subcarriers are synthesized. FIG. 19 shows a spectrum diagram showing an example of amplitude spectrum. In FIG. 19, the horizontal axis shows a frequency and the vertical axis a level.

In the DWMC communications apparatus, several tens to several hundreds of transmission symbols in FIG. 18 are gathered to compose a single transmission frame. The DWMC transmission frame includes symbols for information data transmission as well as symbols for frame synchronization and symbols for equalization.

FIG. 16 is a block diagrams showing the conceptual configuration of a multicarrier transmitter 299 and a multicarrier receiver 199 assumed in case DWMC communications apparatus is employed.

In FIG. 16, a numeral 210 represents a signal point mapping unit for converting bit data to symbol data, 220 a serial-to-parallel (S/P) converter for converting serial data to parallel data, 230 an inverse wavelet transformer for performing inverse wavelet transform, 240 a digital-to-analog (D/A) converter for converting digital data to an analog signal, 110 an analog-to-digital (A/D) converter for converting an analog signal to digital data, 120 a wavelet transformer for performing wavelet transform, 130 a parallel-to-serial (P/S) converter for converting parallel data to serial data, and 140 a determination unit for generating receive data.

In FIG. 16, the multicarrier transmitter 299 uses the signal point mapping unit 210 to convert bit data to symbol data and performs symbol mapping (PAM modulation) in accordance with each symbol data item. The serial-to-parallel converter 220 provides a real numeric value di (i=0 to M-1) for each subcarrier and performs inverse wavelet transform on the time axis by way of the inverse wavelet transformer 230. This generates the sample values on a time-axis waveform and a sample value series representing transmission symbols. The D/A converter 240 converts the sample value series to an analog baseband signal continuous in time for transmission. In this example, the number of sample values on the time axis generated by the inverse wavelet transform is typically 2n (n being a positive integer).

The multicarrier receiver 199 converts the waveform of a receive signal (analog baseband signal) to a digital baseband signal on the A/D converter 110 and samples the resulting signal at the same sampling rate as that of the sending party. The multicarrier receiver 199 performs wavelet transform of the sample value series on the frequency axis by way of the wavelet transformer 120 then converts the data to serial data on the P/S converter (parallel-to-serial converter) 130. Finally, the determination unit calculates the amplitude value of each subcarrier and determines the receive signal to obtain the receive data.

During communications, there may occur amplitude distortion and phase distortion caused by a variation in impedance and multipath interference on a transmission path. Thus it is convenient to be able to process both of the amplitude and phase parameters, that is, complex information. A related art DWMC transmitter, a DWMC receiver and DWMC communications apparatus can process only amplitude information so that they cannot correct distortion depending on the condition of a transmission path, which considerably suppresses the transmission efficiency.

In this way, a related art DWMC transmitter, a DWMC receiver and DWMC communications apparatus can process only amplitude information as transmission data, so that it is impossible to process complex information at the receiving party.

### SUMMARY OF THE INVENTION

The multicarrier transmitter, multicarrier receiver and multicarrier communications apparatus are requested to process complex information as transmission/reception data.

In order to satisfy the requirement, an object of the invention is to provide a multicarrier transmitter capable of processing complex information as transmission data, a multicarrier receiver capable of processing complex information as reception data and multicarrier communications apparatus processing complex information as communications data.

In order to attain the object, a multicarrier transmitter according to the invention is a multicarrier transmitter for performing data transmission by way of digital multicarrier modulation using a real coefficient wavelet filter bank, the multicarrier transmitter comprising: a signal point mapping unit for performing symbol mapping of a series of information; a serial-to-parallel converter for converting serial data as the symbol mapped series of information to parallel data; a first inverse wavelet transformer including a plurality of real coefficient wavelet filters orthogonal to each other; the first inverse wavelet transformer performing a first inverse wavelet transform on the parallel data; a second inverse wavelet transformer including: real coefficient wavelet filters of the first inverse wavelet transformer where Hilbert transform has been made, with the sign of the odd-numbered real coefficient wavelet filters inverted; the second inverse wavelet transformer performing a second inverse wavelet transform on the parallel data; and a modulator for performing SSB modulation by using the output from the first inverse wavelet transformer as an in-phase signal of complex information and the output from the second inverse wavelet transformer as an orthogonal signal of complex information.

This configuration provides a multicarrier transmitter capable of processing complex information as transmission data.

In order to attain the object, a multicarrier receiver according to the invention is a multicarrier receiver for performing data reception by way of digital multicarrier demodulation using a real coefficient wavelet filter bank, the multicarrier receiver comprising: a first multiplier and a second multiplier for downconverting a received bandpass signal to a baseband signal; a local oscillator for providing the first multiplier with a signal of a predetermined frequency; a π/2 phase shifter for delaying the phase of the local oscillator by π/2 to generate a carrier orthogonal to the second multiplier; a first LPF and a second LPF for removing an unwanted signal outside the band of a baseband signal output from each of the first and the second multipliers; a first wavelet transformer for performing wavelet transform on an in-phase signal and an orthogonal signal output from each of the first LPF and the second LPF; an equalizer for equalizing each parallel signal of an in-phase signal and an orthogonal signal output from the first wavelet transformer as a complex signal of each subcarrier; a parallel-to-serial converter for converting a parallel signal output from the equalizer to a serial signal; and a determination unit for determining serial data output from the parallel-to-serial converter.

This configuration provides a multicarrier receiver capable of processing complex information as reception data.

In order to attain the object, multicarrier communications apparatus according to the invention is multicarrier communications apparatus comprising a multicarrier transmitter and a multicarrier receiver, the multicarrier communications apparatus performing data transmission by way of digital multicarrier modulation/demodulation using a real coefficient wavelet filter bank including M real coefficient wavelet filters (M being a positive integer), characterized in that the multicarrier communications transmitter comprises: a signal point mapping unit for converting bit data to symbol data to map the symbol data on M/2 complex coordinate planes; a serial-to-parallel converter for converting serial data as the mapped symbol data to parallel data; a complex data decomposer for inputting the parallel data as well as decomposing complex data into a real part and an imaginary part so as to supply an in-phase component of complex information to the (2n-1) th input to the first and the second inverse wavelet transformers and supply an orthogonal component to the 2nth input (where 1≦n≦(M/2-1), a subcarrier number is 0 to M-1); a first inverse wavelet transformer comprising the M real coefficient wavelet filters orthogonal to each other, the first inverse wavelet transformer outputting an in-phase signal of the complex data; a second inverse wavelet transformer comprising the M real coefficient wavelet filters orthogonal to each other, the second inverse wavelet transformer outputting an orthogonal signal of the complex data; and an SSB modulator for performing SSB modulation by using the output from the first inverse wavelet transformer as an in-phase signal of complex information and the output from the second inverse wavelet transformer as an orthogonal signal of complex information; that the detector of the multicarrier receiver comprises: a multiplier for downconverting a received bandpass signal as a receive signal of a received bandpass signal to a baseband signal; a local oscillator for providing the multiplier with a signal of a predetermined frequency; an LPF for removing an unwanted signal outside the band of a baseband signal output from the multiplier; a first wavelet transformer comprising M real coefficient wavelet filters orthogonal to each other, the first wavelet transformer inputting the output data from the LPF; and a complex data generator for generating complex data by using the (2n-1)th output from the first wavelet transformer as an in-phase component of complex information and 2nth output as an orthogonal component (where 1≦n≦(M/2-1), a subcarrier number is 0 to M-1).

This configuration provides multicarrier communications apparatus capable of processing complex information as communications data.

### BRIEF DESCRIPTION OF THE DRAWINGS

FIG. 1 is a block diagram showing a modulator in a multicarrier transmitter according to Embodiment 1 of the invention;

FIG. 2 is a block diagram showing a first inverse wavelet transformer constituting a modulator in a multicarrier transmitter according to Embodiment 2 of the invention;

FIG. 3 is a block diagram showing a first polyphase prototype filter constituting the first inverse wavelet transformer in FIG. 2;

FIG. 4 is a block diagram showing a second inverse wavelet transformer constituting a modulator in a multicarrier transmitter according to Embodiment 2 of the invention;

FIG. 5 is a block diagram showing a second polyphase prototype filter constituting the second inverse wavelet transformer in FIG. 4;

FIG. 6 is a block diagram showing a multicarrier receiver according to Embodiment 3 of the invention;

FIG. 7 is a block diagram showing a first wavelet transformer constituting a multicarrier receiver according to Embodiment 4 of the invention;

FIG. 8 is a block diagram showing a first polyphase prototype filter constituting the first wavelet transformer in FIG. 7;

FIG. 9 is a block diagram showing a multicarrier receiver according to Embodiment 5 of the invention;

FIG. 10 is a block diagram showing a second wavelet transformer constituting a multicarrier receiver according to Embodiment 6 of the invention;

FIG. 11 is a block diagram showing a second polyphase prototype filter constituting the second inverse wavelet transformer in FIG. 10;

FIG. 12 is a block diagram showing a modulator in a multicarrier transmitter of multicarrier communications apparatus according to Embodiment 7 of the invention;

FIG. 13 is a block diagram showing the detector of a multicarrier receiver of multicarrier communications apparatus according to Embodiment 7 of the invention;

FIG. 14 is a spectrum diagram showing subcarriers;

FIG. 15A is a block diagram showing a multicarrier transmitter of multicarrier communications apparatus according to Embodiment 8 of the invention;

FIG. 15B is a block diagram showing a multicarrier receiver of multicarrier communications apparatus according to Embodiment 8 of the invention;

FIG. 16 is a block diagram showing the conceptual configuration of a multicarrier transmitter and a multicarrier receiver assumed in case DWMC communications apparatus is employed;

FIG. 17 is a graph showing the impulse responses of each subcarrier in DWMC communications apparatus;

FIG. 18 is a waveform diagram showing time waveform data where the impulse responses of the subcarriers are synthesized;

FIG. 19 is a spectrum diagram showing an example of amplitude spectrum; and

FIG. 20 is a frame data diagram showing an example of configuration of a DWMC transmission frame.

### DETAILED DESCRIPTION OF THE PREFERRED EMBODIMENTS

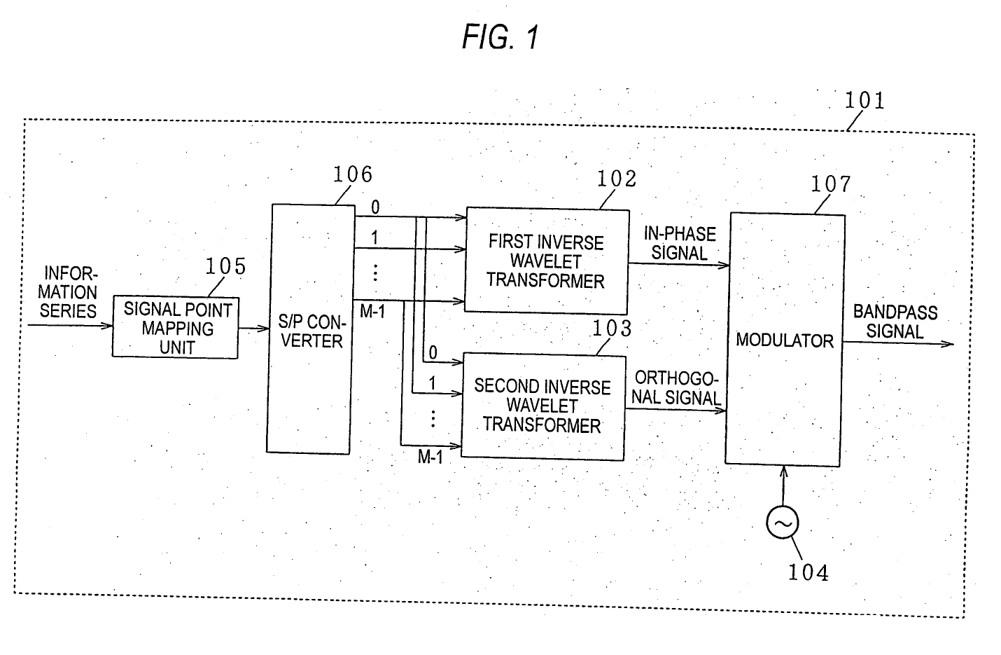

Embodiments of the invention are described below referring to FIGS. 1 through 15. In the embodiments of the invention, wavelet transform and inverse wavelet transform are made by way of a cosine modulation filter bank unless otherwise noted.

### Embodiment 1

FIG. 1 is a block diagram showing a modulator in a multicarrier transmitter according to Embodiment 1 of the invention. The multicarrier receiver will be described in Embodiments 3 through 6.

In FIG. 1, a numeral 101 represents a modulator in a multicarrier transmitter, 105 a signal point mapping unit for performing symbol mapping of a series of information by way of PAM, 106 a serial-to-parallel converter for converting serial data to parallel data, 102 a first inverse wavelet transformer for performing inverse wavelet transform on the parallel data, 103 a second inverse wavelet transformer for performing Hilbert transform on the real coefficient wavelet filters of the first wavelet transformer, the second inverse wavelet transformer including the real coefficient wavelet filters (0 to M-1) of the first inverse wavelet transformer 102 where Hilbert transform has been made, with the sign of the odd-numbered real coefficient wavelet filters inverted, 104 a local oscillator, and 107 a modulator for performing SSB modulation by using an in-phase signal output from the first inverse wavelet transformer 102 and an orthogonal signal output from the second inverse wavelet transformer 103.

Assuming that the number of subcarriers is M and subcarrier numbers 0 to M-1 are assigned, operation of this embodiment is described below referring to FIG. 1.

In the modulator 101, the signal point mapping unit 105 performs symbol mapping on a series of information by way of PAM and the serial-to-parallel converter 106 converts the serial data (the symbol mapped series of information) to parallel data and inputs parallel data outputs to the first inverse wavelet transformer 102 and the second inverse wavelet transformer 103. A signal output from the first inverse wavelet transformer 102 is assumed as an in-phase signal and a signal output from the second inverse wavelet transformer 103 is assumed as an orthogonal signal. An orthogonal signal is a result of Hilbert transform on an in-phase signal. In other words, an orthogonal signal is an in-phase signal with each frequency component shifted by π/2. In the modulator, the local oscillator 104, the in-phase signal and the orthogonal signal are used to perform SSB modulation. In this embodiment, it is assumed that the real coefficient wavelet filter is a finite impulse response (FIR) digital filter. This is the end of the operation of the modulator 101 according to this embodiment.

As described hereinabove, according to this embodiment, a multicarrier transmitter using multicarriers can perform SSB modulation so that it is possible to enhance the frequency use efficiency and process complex information on a multicarrier receiver thereby enhancing upgrading the reception accuracy.

### Embodiment 2

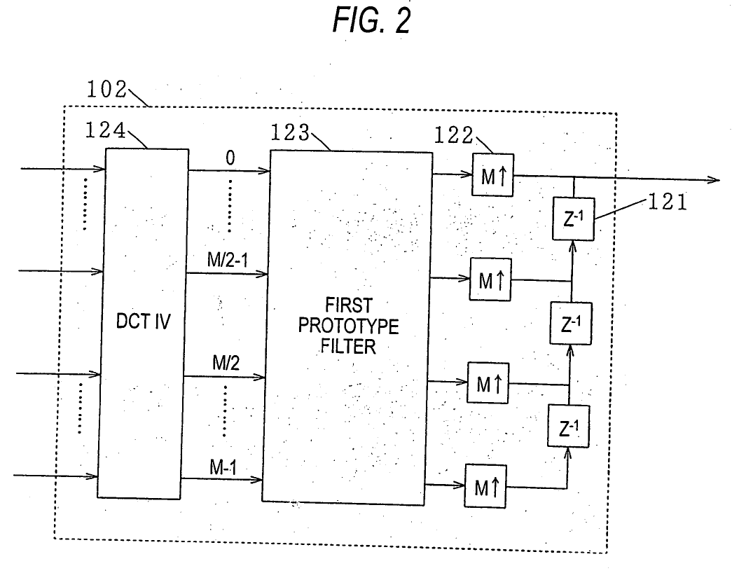

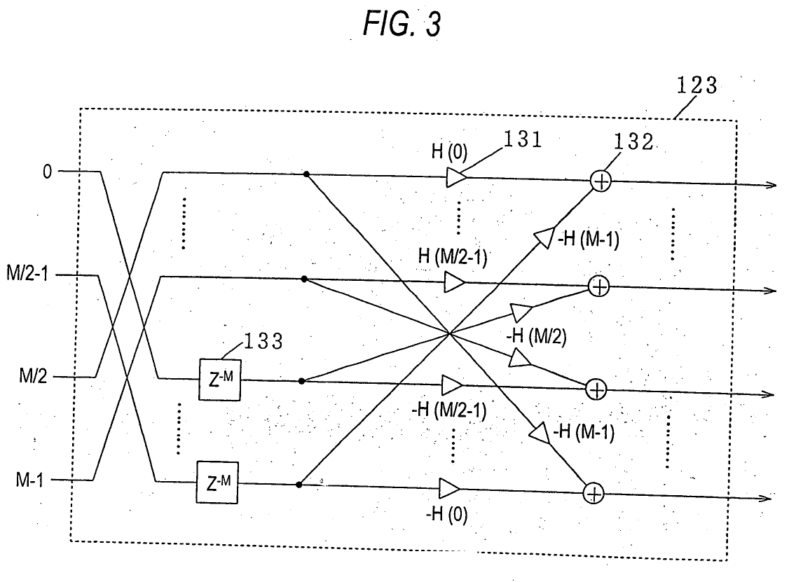

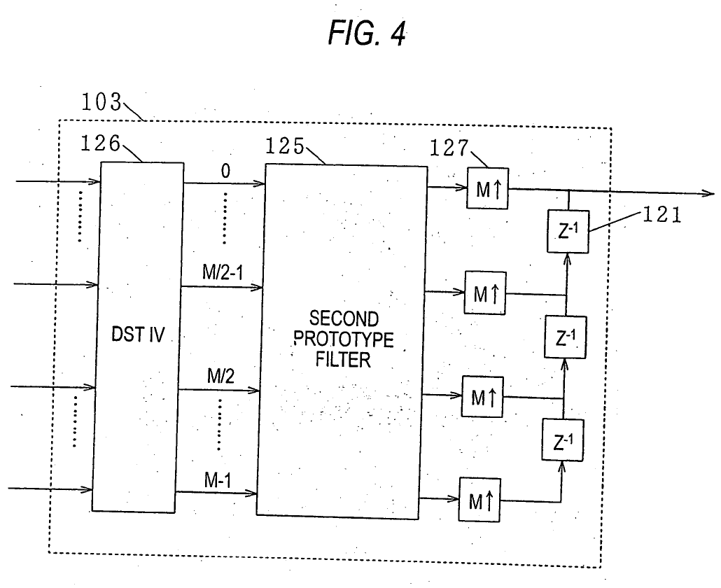

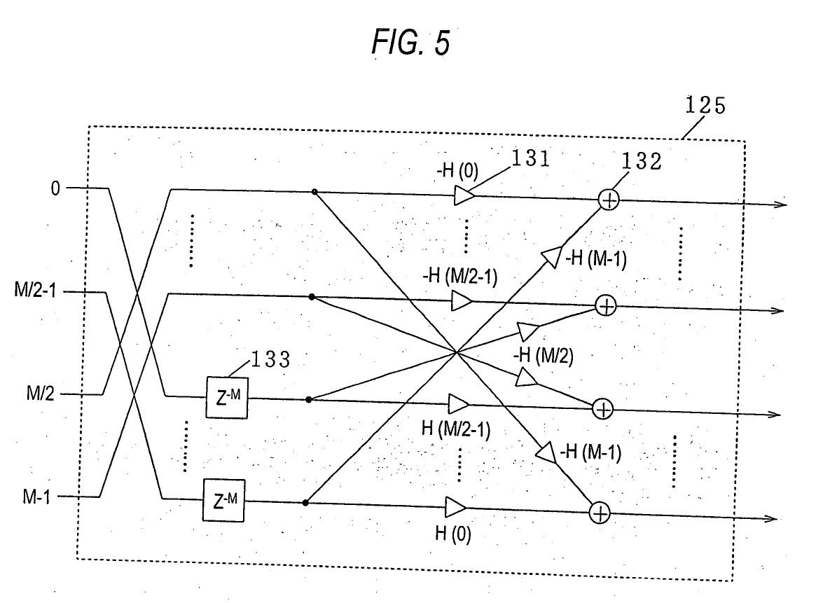

FIG. 2 is a block diagram showing a first inverse wavelet transformer 102 constituting a modulator in a multicarrier transmitter according to Embodiment 2 of the invention. The configuration of the modulator in a multicarrier transmitter according to Embodiment 2 of the invention is the same as that shown in FIG. 1, similar to Embodiment 1. FIG. 3 is a block diagram showing a first polyphase prototype filter constituting the first inverse wavelet transformer 102 in FIG. 2. FIG. 4 is a block diagram showing a second inverse wavelet transformer 103 constituting a modulator in a multicarrier transmitter according to Embodiment 2 of the invention. FIG. 5 is a block diagram showing a second polyphase prototype filter constituting the second inverse wavelet transformer 103 in FIG. 4.

In FIG. 2, a numeral 102 represents a first inverse wavelet transformer, 121 a delay element for delaying send data by a single sampling period, 122 an upsampler for multiplying M-fold the sampling rate of send data, 123 a first prototype filter, and 124 a high-speed discrete cosine transformer (TYPE 4). In FIG. 2, the delay elements 121 are M-1 in number and the upsamplers 122 are M in number.

In FIG. 3, a numeral 123 represents a first prototype filter, 131 a multiplier having the filter coefficient of the first prototype filter, 132 a two-input adder, and 133 a delay element for delaying send data by a single symbol period (M sampling periods). Note that the order of the first prototype filter 123 shown in FIG. 3 is 2M.

In FIG. 4, a numeral 103 represents a second inverse wavelet transformer, 121 a delay element for delaying send data by a single sampling period, 122 an upsampler for multiplying the sampling rate of send data, 125 a second prototype filter, and 126 a high-speed discrete sine transformer (TYPE 4). In FIG. 4, the delay elements 121 are M-1 in number and the upsamplers 122 are M in number.

In FIG. 5, a numeral 125 represents a second prototype filter, 131 a multiplier having the filter coefficient of the second prototype number, 132 a two-input adder, and 133 a delay element for delaying send data by a single symbol period (M sampling periods). Note that the order of the second prototype filter shown in FIG. 5 is 2M.

Operation of Embodiment 2 is the same as that of Embodiment 1 except that the portion implemented by an FIR filter in Embodiment 1 is implemented by the polyphase-based prototype filter as well as the high-speed discrete cosine transformer 124 and the high-speed discrete sine transformer 126 for performing high-speed discrete cosine transform and high-speed discrete sine transform, respectively, in Embodiment 2.

While the first inverse wavelet transformer (inverse wavelet transformer 102) and the second inverse wavelet transformer (inverse wavelet transformer 103) are totally different from each other in this embodiment, they can be implemented by sharing the same circuit configuration (for example sharing DCT4 without using DST4). This is clear from the fact that the filter coefficients of the prototype filters of these inverse wavelet transformers are only inverted and that the discrete cosine transform and the discrete sine transform use different processing coefficients and are otherwise the same.

As described hereinabove, according to this embodiment, the first inverse wavelet transformer 102 comprises: a high-speed discrete cosine transformer 124 for inputting parallel data from the serial-to-parallel converter 106; a first prototype filter 123 including a polyphase filter having a real coefficient, the first prototype filter inputting output data of the high-speed discrete cosine transformer 124; M upsamplers 122 for inputting output data of the first prototype filter 123; and M-1 single sample delay elements for inputting output data of the upsamplers 122. The second inverse wavelet transformer 103 comprises: a high-speed discrete sine transformer 126 for inputting parallel data from the serial-to-parallel converter 106; a second prototype filter 125 including a polyphase filter having a real coefficient, the second prototype filter inputting output data of the high-speed discrete sine transformer 126; M upsamplers 122 for inputting output data of the second prototype filter 125; and M-1 single sample delay elements for inputting output data of the upsamplers 122. It is thus possible to perform the first inverse wavelet transform and the second inverse wavelet transform at high speed so that it is possible to perform data transmission at high speed (at a higher speed than in Embodiment 1) as a whole.

### Embodiment 3

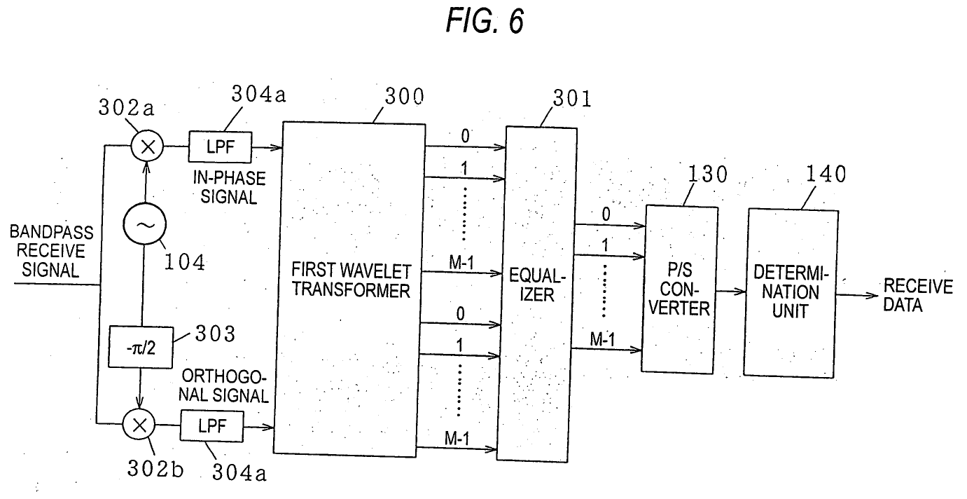

FIG. 6 is a block diagram showing a multicarrier receiver according to Embodiment 3 of the invention.

In FIG. 6, numerals 302a, 302b represent a first multiplier and a second multiplier for downconverting a received bandpass signal (bandpass receive signal), 104 represents a local oscillator, 303 a π/2 phase shifter for delaying the phase of the local oscillator by π/2 304a, 304b a first LPF and a second LPF (Low Pass Filter) for removing an unwanted signal, 300 a first wavelet transformer for performing wavelet transform on an in-phase signal and an orthogonal signal, 301 an equalizer for equalizing each parallel signal of an in-phase signal and an orthogonal signal output from the first wavelet transformer 300 as complex information per subcarrier, 130 a parallel-to-serial converter for converting parallel data to serial data, and 140 a determination unit.

Operation of thus configured multicarrier receiver is described below.

In FIG. 6, the bandpass receive signal is downconverted to an in-phase signal and an orthogonal signal respectively and these signals are passed through the LPF 304. The in-phase signal and the orthogonal signal are input to the first wavelet transformer 300 for wavelet transform. The equalizer 301 compares, as complex data per subcarrier, the parallel data of an in-phase signal and an orthogonal signal output from the first wavelet transformer 300 with known data previously assigned for equalization and obtains an equalization volume. Then, the equalizer 301 equalizes, in an actual data transmission section, the complex data by using the previously obtained equalization volume and supplies the equalized data to the parallel-to-serial converter 130. The parallel-to-serial converter 130 converts the equalized complex data to serial data. Finally, the determination unit 140 makes data determination based on the equalized complex data in the form of serial data. This is the end of a series of operation. The equalizer 301 obtains per subcarrier the amplitude and the phase dislocation from a known signal as an equalization volume. Depending on the transmission path, it is possible to use an adaptive filter (LMS or RLS).

As described hereinabove, a multicarrier receiver according to this embodiment comprises: a first multiplier 302a and a second multiplier 302b for downconverting a received bandpass signal to a baseband signal, a local oscillator 104 for providing the first multiplier 302a with a signal of a predetermined frequency; a π/2 phase shifter 303 for delaying the phase of the local oscillator 104 by π/2 to generate a carrier orthogonal to the second multiplier 302b; a first LPF 304a and a second LPF 304b for removing an unwanted signal outside the band of baseband signal output from each of the first multiplier 302a and the second multiplier 302b; an equalizer 301 for equalizing each parallel signal of an in-phase signal and an orthogonal signal output from the first wavelet transformer 300 as complex information per subcarrier; a parallel-to-serial converter 130 for converting a parallel signal output from the equalizer 301 to a serial signal; and a determination unit 140 for determining the serial data output from the parallel-to-serial converter 130. It is thus possible to receive a send signal containing SSB-modulated complex information to obtain complex information by way of a single type of real coefficient wavelet filter bank and perform equalization using the complex information, thereby enhancing the reception accuracy, that is, perform high-accuracy demodulation even on a non-linear transmission path.

### Embodiment 4

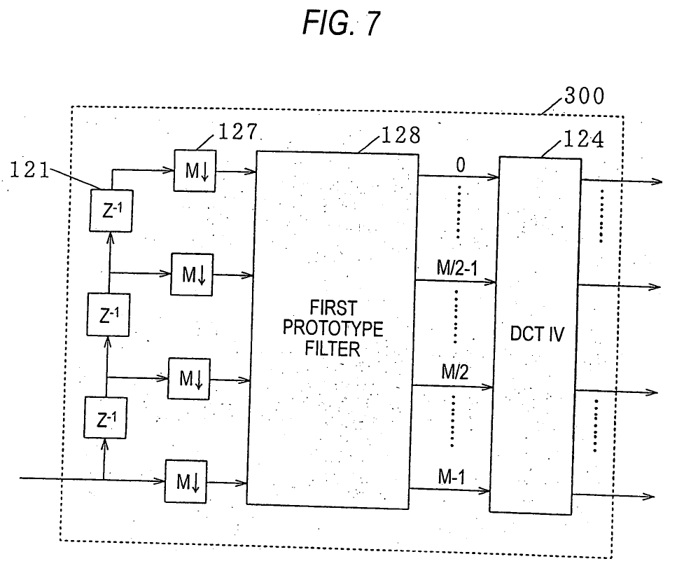

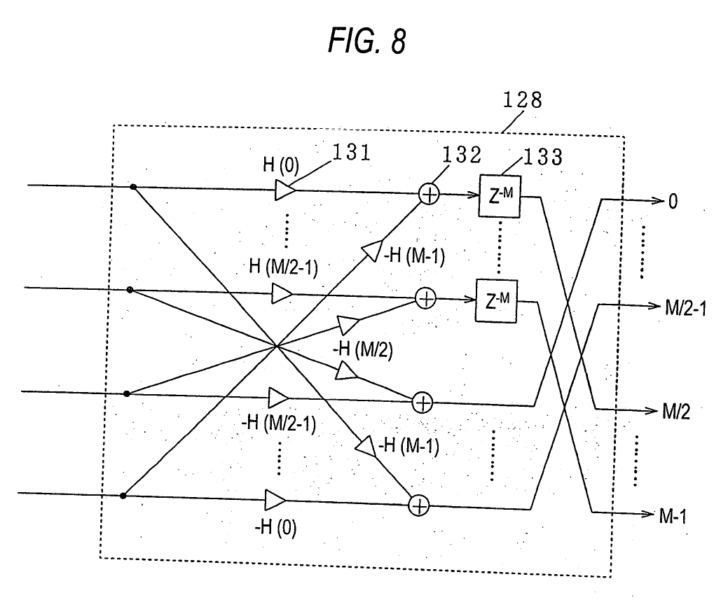

FIG. 7 is a block diagram showing a first wavelet transformer 300 constituting a multicarrier receiver according to Embodiment 4 of the invention. The configuration of a multicarrier receiver according to Embodiment 4 is shown in FIG. 6, same as Embodiment 3. FIG. 8 FIG. 8 is a block diagram showing a first polyphase prototype filter constituting the first wavelet transformer in FIG. 7.

In FIG. 7, a numeral 300 represents a first wavelet transformer, 121 a delay element for delaying a receive signal (an in-phase signal and an orthogonal signal in this example) by a single sampling period, 127 a downsampler for dividing the sampling rate of the receive signal by M, 128 a first prototype filter, and 124 a high-speed discrete cosine transformer (TYPE4) In FIG. 7, the delay elements 121 are M-1 in number and the downsamplers 127 are M in number.

In FIG. 8, a numeral 128 represents a first prototype filter, 131 a multiplier having the filter coefficient of the first prototype filter 128, 132 a two-input adder, and 133 a delay element for delaying receive data by a single symbol period (M sampling periods). Note that the order of the first prototype filter 128 shown in FIG. 8 is 2M.

Operation of Embodiment 4 is the same as that of Embodiment 3 except that the portion implemented by an FIR filter in Embodiment 3 is implemented by the first polyphase-based prototype filter as well as the high-speed discrete cosine transformer 124 for performing high-speed discrete cosine transform in Embodiment 4.

As described hereinabove, according to this embodiment, the first wavelet transformer 300 comprises: M-1 single sample delay elements 121 for inputting an in-phase signal and an orthogonal signal output from the first LPF 304a and the second LPF 304b; M upsamplers 127 for inputting output data of the single sample delay elements 121; a first prototype filter 128 for inputting output data of the M upsamplers 127; and a high-speed discrete cosine transformer 124 for inputting output data of the first prototype filter 128. It is thus possible to perform a first wavelet transform at high speed so that it is possible to perform data reception at high speed (at a higher speed than in Embodiment 3) as a whole.

### Embodiment 5

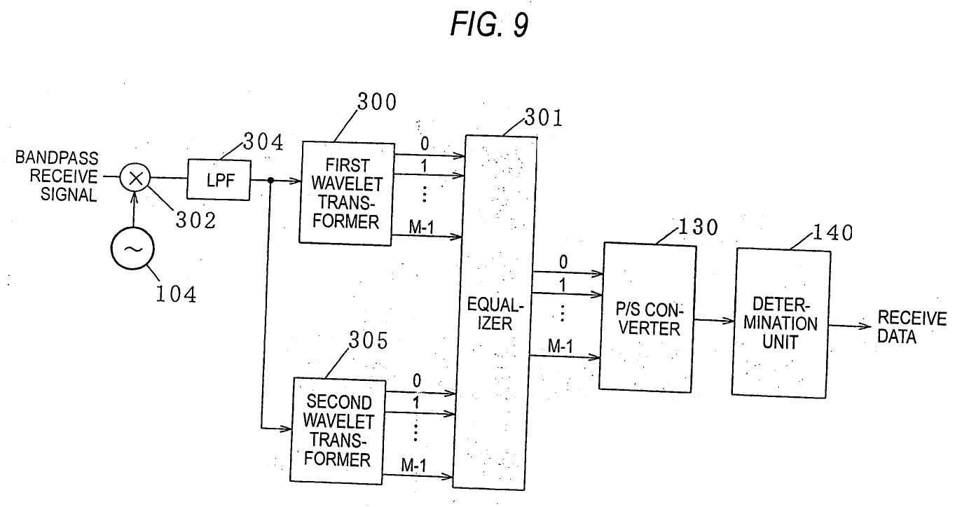

FIG. 9 is a block diagram showing a multicarrier receiver according to Embodiment 5 of the invention.

In FIG. 9, a numeral 302 represents a multiplier for down converting a bandpass receive signal, 104 a local oscillator, 304 an LPF for removing an unwanted wave, 300 a first wavelet transformer for performing wavelet transform on an in-phase signal, 305 a second wavelet transformer for performing Hilbert transform on the real coefficient wavelet filters of the first wavelet transformer 300, the second wavelet transformer including the real coefficient wavelet filters (0 to M-1) of the first wavelet transformer 300 where Hilbert transform has been made, with the sign of the odd-numbered real coefficient wavelet filters inverted, the second wavelet transformer performing wavelet transform on an orthogonal signal, 301 an equalizer for equalizing each parallel signal of an in-phase signal output from the first wavelet transformer 300 and an orthogonal signal output from the second wavelet transformer 305 as complex information per subcarrier, 130 a parallel-to-serial converter for converting parallel data to serial data, and 140 a determination unit.

Operation of thus configured multicarrier receiver is described below.

In FIG. 9, the bandpass receive signal is downconverted to an in-phase signal and the in-phase signal is passed through the LPF 340. The downconverted signal is input to the first wavelet transformer 300 and the second wavelet transformer 305 for respective wavelet transform. The equalizer 301 compares, as complex data per subcarrier, the parallel data of an in-phase signal output from the first wavelet transformer 300 and an orthogonal signal output from the second wavelet transformer 305 with known data previously assigned for equalization and obtains an equalization volume. Then, the equalizer 301 equalizes, in an actual data transmission section, the complex data by using the previously obtained equalization volume and supplies the equalized data to the parallel-to-serial converter 130. The parallel-to-serial converter 130 converts the equalized complex data to serial data. Finally, the determination unit 140 makes data determination based on the equalized complex data in the form of serial data. This is the end of a series of operation. In the wavelet transform, type types of wavelet transformers 300, 305 are used while the downconverting is made by way of a single system. By using a related art Hilbert transformer, the first wavelet transformer 300 and an inverter (and a level converter as desired to enhance the accuracy) instead of the second wavelet transformer 305, operation in FIG. 9 is allowed through single-system downconversion and one type of wavelet transformer. This is clear from the fact that the second wavelet transformer 305 comprises the real coefficient wavelet filters (0 to M-1) of the first wavelet transformer 300 where Hilbert transform has been made, with the sign of the odd-numbered real coefficient wavelet filters inverted. The equalizer 301 obtains per subcarrier the amplitude and the phase dislocation from a known signal as an equalization volume. Depending on the transmission path, it is possible to use an adaptive filter (LMS or RLS)

As described hereinabove, a multicarrier receiver according to this embodiment comprises: a multiplier 302 for downconverting a received bandpass signal to a baseband signal, a local oscillator 104 for providing the multiplier 302 with a signal of a predetermined frequency; an LPF 304 for removing an unwanted signal outside the band of a baseband signal output from the multiplier 302; a first wavelet transformer 300 for performing a first wavelet transform on an output signal from the LPF 304; a second wavelet transformer 305 for performing Hilbert transform on the real coefficient wavelet filters of the first wavelet transformer 300, the second wavelet transformer including the real coefficient wavelet filters (0 to M-1) of the first wavelet transformer 300 where Hilbert transform has been made, with the sign of the odd-numbered real coefficient wavelet filters inverted, the second wavelet transformer performing a second wavelet transform on an output signal from the LPF 304; an equalizer 301 for equalizing each parallel signal of an in-phase signal output from the first wavelet transformer 300 and an orthogonal signal output from the second wavelet transformer 305 as a complex signal of each subcarrier; a parallel-to-serial converter 130 for converting an equalized parallel signal output from the equalizer 301 to serial data; and a determination unit 140 for determining serial data output from the parallel-to-serial converter 130. It is thus possible to receive a send signal containing SSB-modulated complex information to obtain complex information by way of two types of real coefficient wavelet filter banks in case downconversion is made by way of a single system and perform equalization using the complex information, thereby enhancing the reception accuracy, that is, perform high-accuracy demodulation even on a non-linear transmission path.

### Embodiment 6

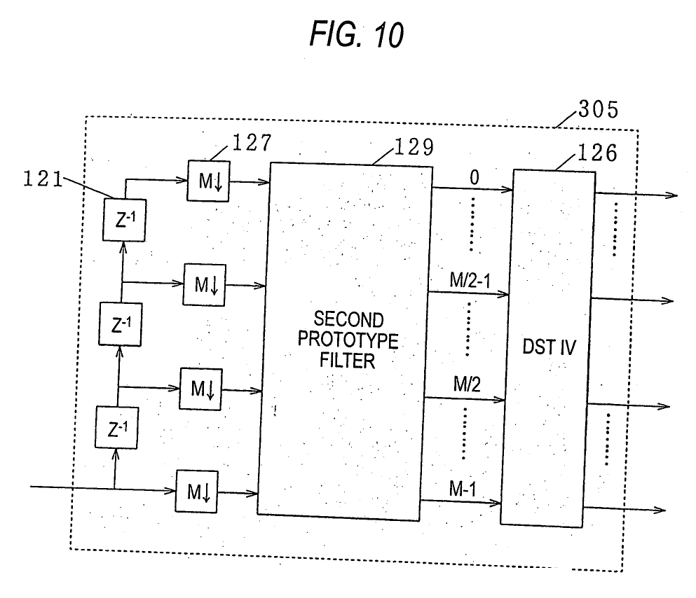

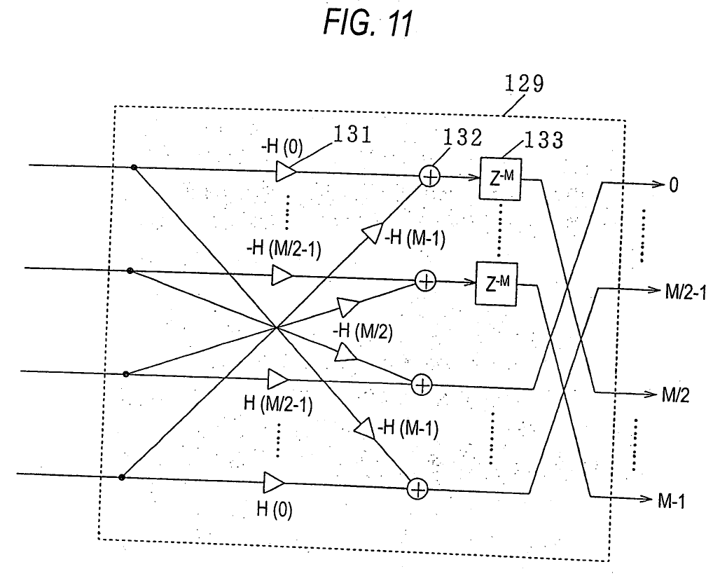

FIG. 10 is a block diagram showing a second wavelet transformer 305 constituting a multicarrier receiver according to Embodiment 6 of the invention. The configuration of the multicarrier receiver according to Embodiment 6 of the invention is the same as that shown in FIG. 9, similar to Embodiment 5. The configuration of the first wavelet transformer according to this embodiment is that shown in FIG. 7 and FIG. 8. FIG. 11 is a block diagram showing a second polyphase prototype filter constituting the second inverse wavelet transformer in FIG. 10.

In FIG. 10, a numeral 305 represents a second wavelet transformer, 121 a delay element for delaying a receive signal by a single sampling period, 127 a downsampler for dividing the sampling rate of the receive signal by M, 129 a second prototype filter, and 126 a high-speed discrete sine transformer (TYPE4). In FIG. 10, the delay elements 121 are M-1 in number and the downsamplers 127 are M in number.

In FIG. 11, a numeral 129 represents a second prototype filter, 131 a multiplier having the filter coefficient of the second prototype filter 129, 132 a two-input adder, and 133 a delay element for delaying receive data by a single symbol period (M sampling periods). Note that the order of the first prototype filter 128 shown in FIG. 11 is 2M.

Operation of Embodiment 6 is the same as that of Embodiment 5 except that the portion implemented by an FIR filter in Embodiment 5 is implemented by the first polyphase-based prototype filter 129 as well as the high-speed discrete sine transformer 126 for performing high-speed discrete sine transform in Embodiment 6.

While the first wavelet transformer (wavelet transformer 300) and the second wavelet transformer (wavelet transformer 305) are totally different from each other in this embodiment, they can be implemented by sharing the same circuit configuration (for example sharing DCT4 without using DST4). This is clear from the fact that the filter coefficients of the prototype filters of these wavelet transformers are only inverted and that the discrete cosine transform and the discrete sine transform use different processing coefficients and are otherwise the same.

As described hereinabove, according to this embodiment, the first wavelet transformer 300 comprises: M-1 single sample delay elements 121 for inputting an output signal of the LPF 304; M upsamplers 127 for inputting output data of the single sample delay elements 121; a first prototype filter 128 for inputting output data of the M upsamplers 127; and a high-speed discrete cosine transformer 124 for inputting output data of the first prototype filter 128. The second wavelet transformer 305 comprises: M-1 single sample delay elements 121 for inputting an output signal of the LPF 304; M upsamplers 127 for inputting output data of the single sample delay elements 121; a second prototype filter 129 for inputting output data of the M upsamplers 127; and a high-speed discrete sine transformer 126 for inputting output data of the second prototype filter 129. It is thus possible to perform a first wavelet transform and a second wavelet transform at high speed so that it is possible to perform data reception at high speed (at a higher speed than in Embodiment 5) as a whole.

### Embodiment 7

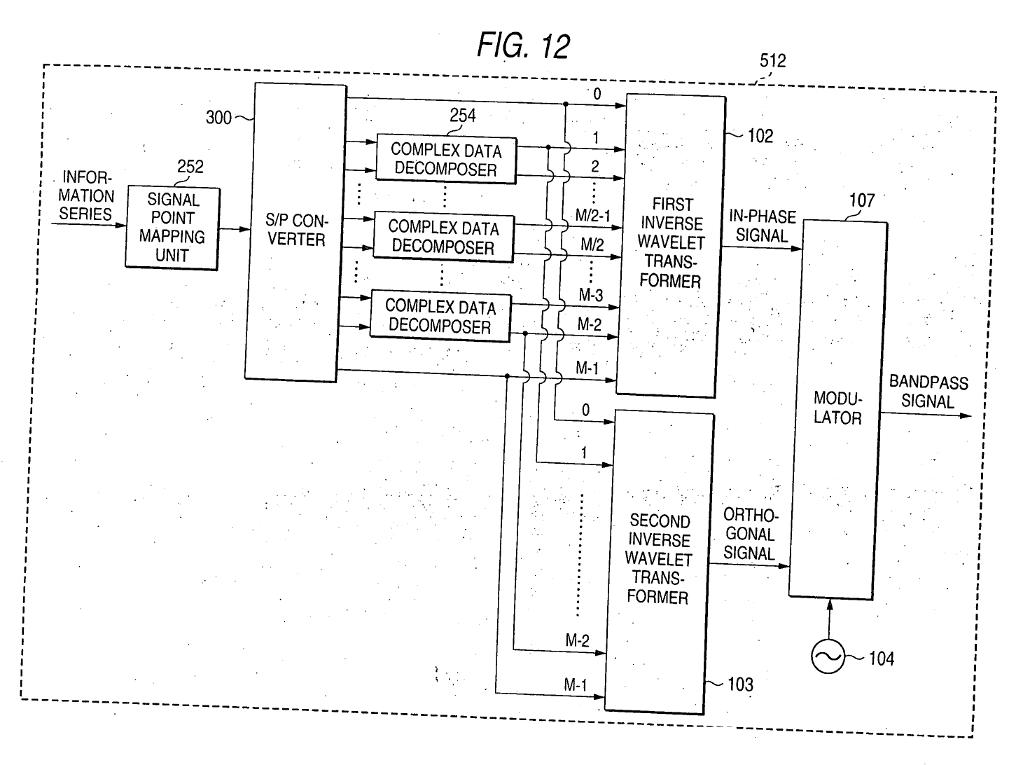

FIG. 12 is a block diagram showing a modulator in a multicarrier transmitter of multicarrier communications apparatus according to Embodiment 7 of the invention.

In FIG. 12, a numeral 251 represents an SSB modulator, 252 a signal point mapping unit for converting bit data to symbol data to map the symbol data on M/2 (half of the M real coefficient wavelet filters) complex coordinate planes, the mapping referred to as QAM or Quadrature Amplitude Modulation, 253 a serial-to-parallel converter for converting serial data to parallel data, 254 a complex data decomposer for decomposing complex data into a real part and an imaginary part so as to supply an in-phase component of complex information (I channel) to the (2n-1) th input to the first and the second inverse wavelet transformers and supply an orthogonal component (Q channel) to the 2nth input (where 1≦n≦(M/2-1), a subcarrier number is 0 to M-1), 104 a local oscillator, and 107 a modulator for performing SSB modulation by using an in-phase signal output from the first inverse wavelet transformer 102 and an orthogonal signal output from the second inverse wavelet transformer 103.

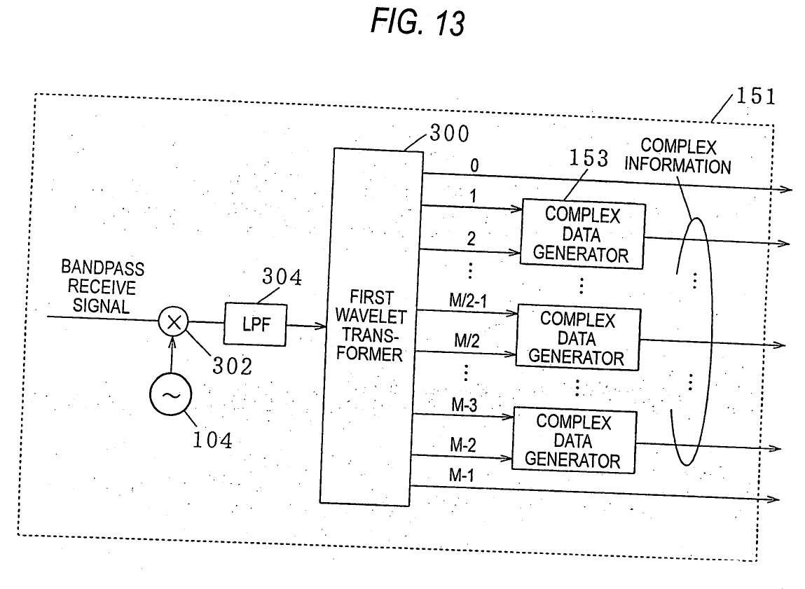

FIG. 13 is a block diagram showing the detector of a multicarrier receiver of multicarrier communications apparatus according to Embodiment 7 of the invention.

In FIG. 13, a numeral 151 represents a detector of the multicarrier receiver, 302 a multiplier for downconverting a bandpass receive signal, 104 a local oscillator, 304 an LPF for removing an unwanted wave, 300 a first wavelet transformer comprising M real coefficient wavelet filters orthogonal to each other, and 153 a complex data generator for generating complex data by using the (2n-1)th output from the first wavelet transformer 300 as an in-phase component (I channel) of complex information and 2nth output as an orthogonal component (Q channel) (where 1≦n≦(M/2-1), a subcarrier number is 0 to M-1)

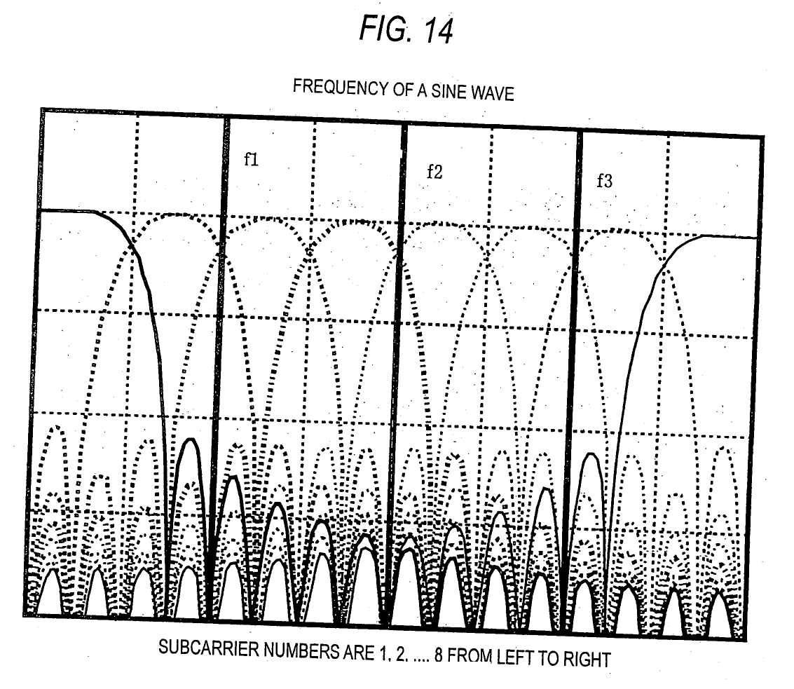

Operation of the SSB modulator 251 in FIG. 12 is described referring to FIG. 12 and FIG. 14. FIG. 14 is a spectrum diagram showing subcarriers. For simplicity, it is assumed that the number of subcarriers is 8. Further, it is assumed in this embodiment that a composite wave of sine waves having the portions in bold lines (f1, f2, f3) shown in FIG. 14 as frequencies is output from the multicarrier transmitter and their phases φ1, φ2, and φ3. The phase φn of each sine wave (n=1, 2, 3) is arbitrary within the range of −π to π.

The SSB modulator 251 uses the signal point mapping unit 252 to convert send data (bit data) to symbol data and perform QAM modulation in accordance with each symbol data item to map signal points on a complex coordinates. This processing obtains exp (jφn). Then the resulting data is converted to parallel complex data by the serial-to-parallel converter 253. Each complex data item is decomposed into real part data (cos(φn)) and imaginary part data (sin(φn)) by way of the complex data decomposer 254. Then, (cos(φn)) is assigned to the (2n-1)th input to the first inverse wavelet transformer 102 and the second inverse wavelet transformer 103, and (sin(φn)) to the 2nth input thereto (where 1≦n≦(M/2-1)). The output of each of the inverse wavelet transformers 102, 103 appears as a composite wave of sine waves cos(2πfn·t+φn) having a frequency fn in FIG. 14 and an initial phase φn.

While (M/2-1) complex data decomposers 254 in total are used in this embodiment, a single complex data decomposer may be used to provide the embodiment. To be more precise, outputs from the complex data decomposers 254 are converted to serial data and timing control is made so that the (2n-1)th and 2nth data items will be input to the complex data decomposers 254. It is also possible to apply Embodiment 2 to perform inverse wavelet transform at high speed.

Operation of the detector 151 in this embodiment is described below referring to FIG. 13 and FIG. 14.

The detector 151 performs wavelet transform on a receive signal by way of the first wavelet transformer 300. In this practice, the (2n-1)th and 2nth subcarrier outputs respectively serve as cos(φn) and sin(φn) to a sine wave having a frequency fn in FIG. 14. The complex data generator 153 generates complex data assuming cos(φn) as real part data and sin(φn) as imaginary part data. After that, the output signal is typically input to an equalizer.

While (M/2-1) complex data generators 153 in total are used in this embodiment, a single complex data generator may be used to provide the embodiment by converting outputs from the wavelet transformers to serial data and making timing control so that the (2n-1)th and 2nth data items will be input to the complex data generators. It is also possible to apply Embodiment 4 to perform wavelet transform at high speed.

As described hereinabove, a multicarrier transmitter according to this embodiment can arbitrarily give an initial phase on a complex coordinate plane mapped by the signal point mapping unit 252 to each subcarrier pair (strictly speaking, a pair comprising the (2n-1)th and the 2nth subcarriers). It is thus possible to suppress the instantaneous peak voltage during transmission by setting data so that the phase of each subcarrier pair will not overlap one on the other. It is made possible to relax the specifications for the transmission amplifier. A multicarrier transmitter according to this embodiment can obtain complex information with reduced arithmetic operation volume (about half that in Embodiment 3 or 5) in terms of a receive signal comprising sine waves.

### Embodiment 8

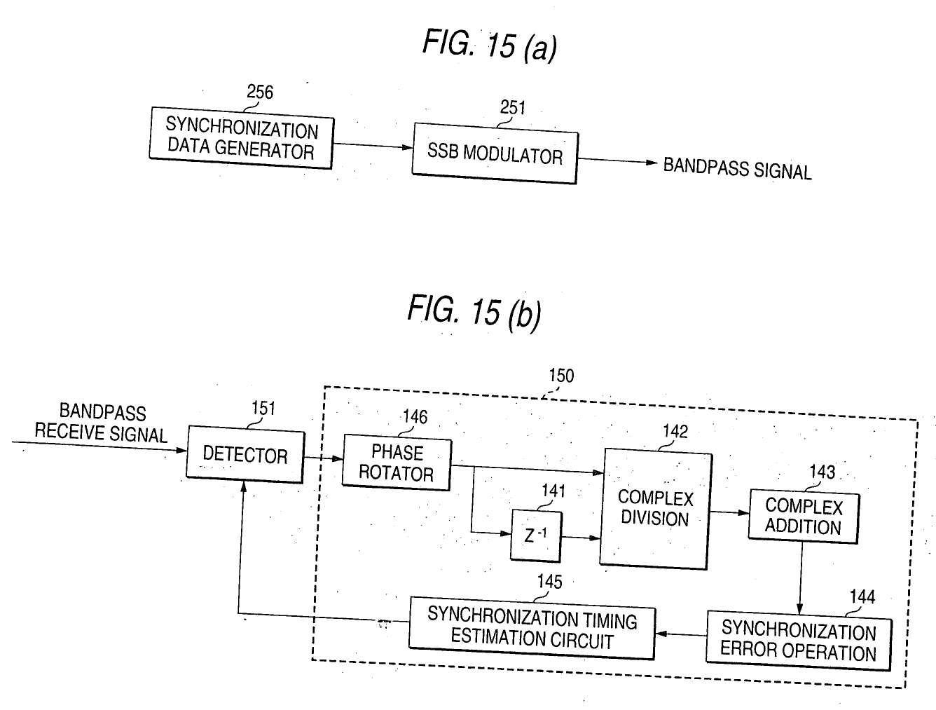

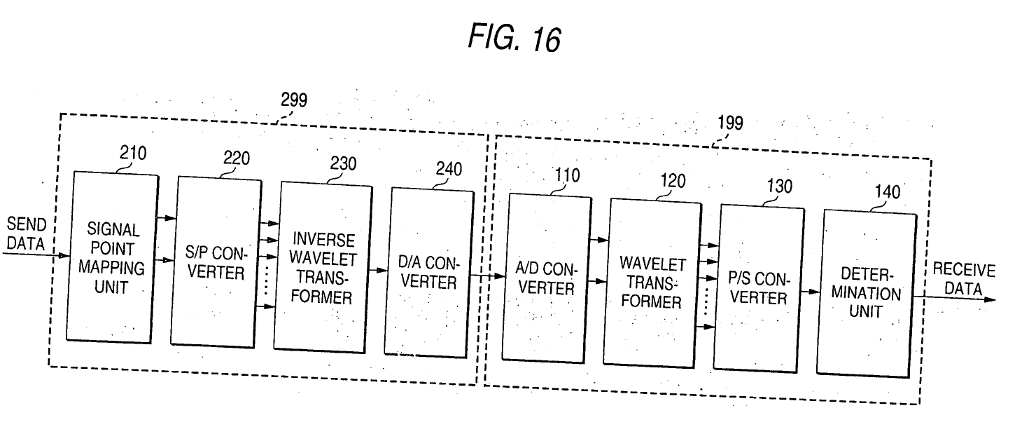

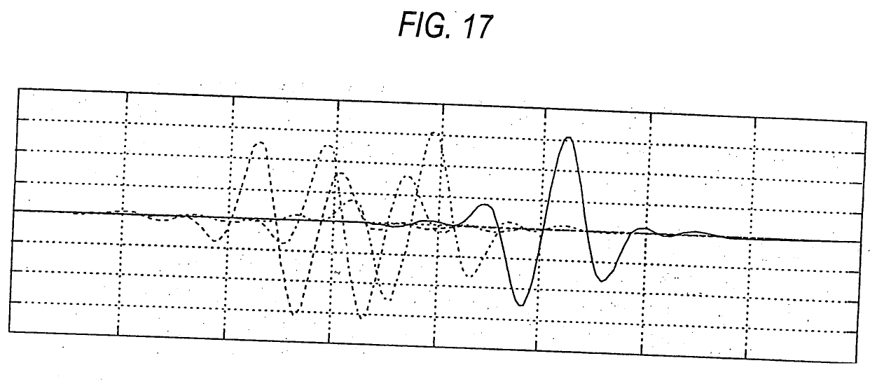

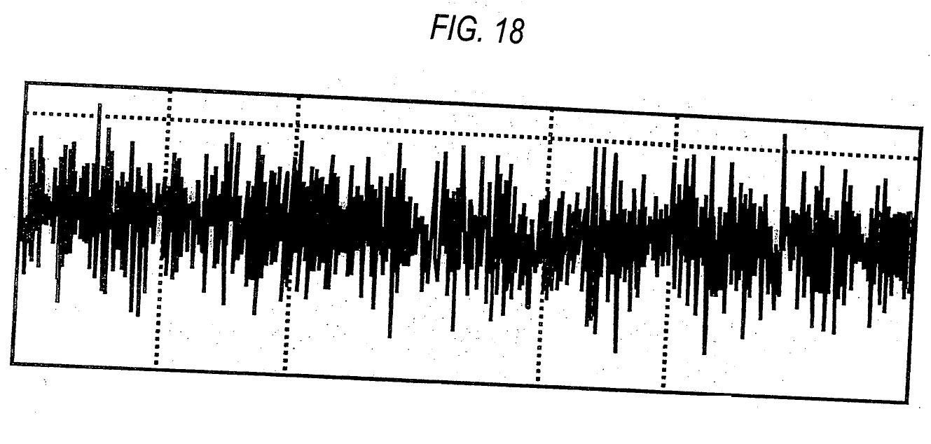

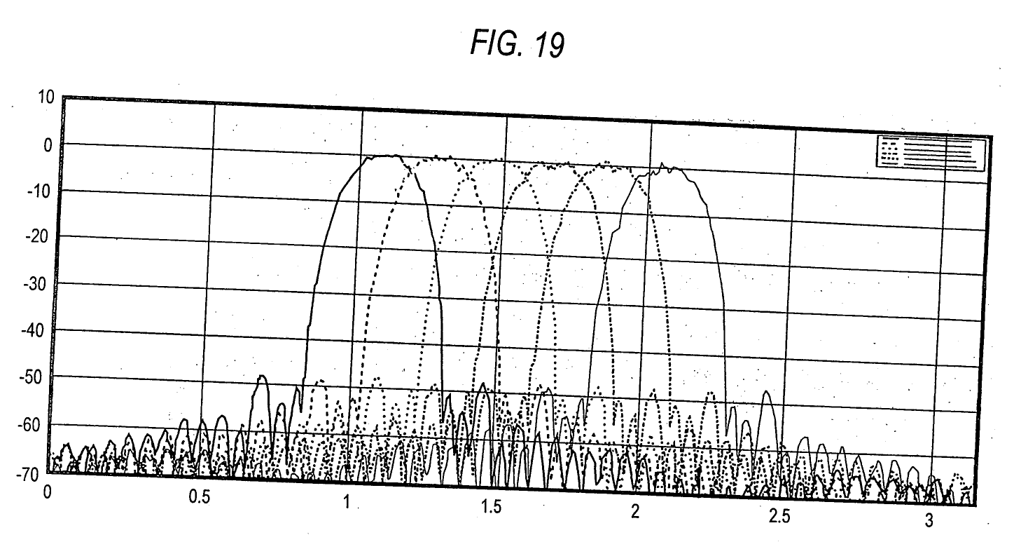

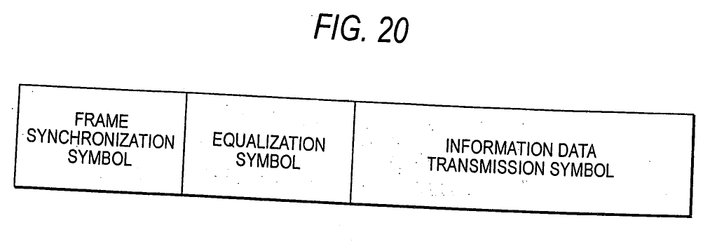

FIG. 15A is a block diagram showing a multicarrier transmitter of multicarrier communications apparatus according to Embodiment 8 of the invention. FIG. 15B is a block diagram showing a multicarrier receiver of multicarrier communications apparatus according to Embodiment 8 of the invention.

In FIG. 15A, a numeral 256 represents a synchronization data generator for generating the same data (data used as a preamble or pilot signal) for each subcarrier and 251 a modulator (SSB modulator in this example) of the same configuration as that in FIG. 12. In FIG. 15B, a numeral 151 represents a detector of the same configuration as that in FIG. 13, 146 a phase rotator for rotating a phase on a complex plane, 141 a delay circuit for delaying data by a single sampling period, 142 complex division, 143 complex addition for summing up input complex data, 144 synchronization error operation, 145 a synchronization timing estimation circuit, and 150 a synchronization estimation circuit.

Operation of the multicarrier transmitter thus configured is described below referring to FIG. 14 and FIG. 15. The number of wavelet transforms is 8, that is, the number of subcarriers is 8 in this example.

In the multicarrier transmitter in FIG. 15A, the synchronization data generator 256 outputs the same data (data used as a preamble or pilot signal) for each subcarrier to the SSB modulator 251. The data assigned to each subcarrier is data known to the multicarrier transmitter in FIG. 15A. The synchronization data is then modulated by the SSB modulator 251. The output from the SSB modulator 251 is a composite wave of sine waves having a frequency of fn shown in FIG. 14. The phase of each sine wave depends on the synchronization data. The phase is φn in this example. This is the end of the operation of the multicarrier transmitter.

In the multicarrier receiver in FIG. 15B, a received signal is detected by the detector 151. As an output from the detector 151, complex signal point information is obtained for a plurality of sine waves contained in the receive signal. Concerning the complex signal point information, the phase of the signal is rotated by φn from the actual signal point mapping by a multicarrier transmitter. To correct this, the phase rotator 146 is used to return the phase by φn on the complex coordinates. Further, in case the symbol synchronization timing is correct, each output from the phase rotator 146 is the same value. In case synchronization timing is not synchronized, the value obtained has undergone phase rotation of 2πfc·τ (where τ is the degree of dislocation, fc is a subcarrier frequency). Next, the delay element 141 and the complex operation 142 are used to perform complex division of adjacent subcarriers to calculate a phase difference on the complex coordinates. The frequency interval fi between adjacent subcarriers is constant so that the phase difference between subcarriers is a same value of 2πfi·τ (in reality, the value varies depending on the conditions of the transmission path) The phase difference between subcarriers is summed up by the complex addition 143 to obtain an average value φm. In the synchronization error operation 144, a synchronization error value τ is obtained from the interval between subcarriers f1 and the average phase difference between subcarriers φm. The result is given to the synchronization timing estimation circuit 145 to feed back the synchronization timing to the detector 151. This is the end of a series of operation according to this embodiment.

As described hereinabove, according to this embodiment, a portion comprising two wavelet transformers in Embodiments 3 through 6 can be implemented with a single wavelet transformer, so that it is possible to reduce the arithmetic operation volume while the synchronization circuit is operating (during preamble interval).

### CROSS REFERENCE TO RELATED APPLICATION

This application is based upon and claims the benefit of priority of Japanese Patent Application No. 2002-340586 filed on Nov. 25, 2002, the contents of which are incorporated herein by reference in its entirety.

What is claimed is:

1. A multicarrier transmitter for performing data transmission by way of digital multicarrier modulation using a real coefficient wavelet filter bank, said multicarrier transmitter comprises:
a signal point mapping unit for performing symbol mapping of a series of information;
a serial-to-parallel converter for converting serial data as said symbol mapped series of information to parallel data;
a first inverse wavelet transformer including a plurality of real coefficient wavelet filters orthogonal to each other, said first inverse wavelet transformer performing a first inverse wavelet transform on said parallel data;
a second inverse wavelet transformer including: real coefficient wavelet filters of said first inverse wavelet transformer where Hilbert transform has been made, with the sign of the odd-numbered real coefficient wavelet filters inverted, said second inverse wavelet transformer performing a second inverse wavelet transform on said parallel data; and
a modulator for performing SSB modulation by using the output from said first inverse wavelet transformer as an in-phase signal of complex information and the output from the second inverse wavelet transformer as an orthogonal signal of complex information.

2. The multicarrier transmitter according to claim 1, wherein said first inverse wavelet transformer comprises:
a high-speed discrete cosine transformer for inputting parallel data from the serial-to-parallel converter;
a first prototype filter including a polyphase filter having a real coefficient, said first prototype filter inputting output data of said high-speed discrete cosine transformer;
M upsamplers for inputting output data of said first prototype filter; and
M-1 single sample delay elements for inputting output data of said upsamplers.

3. The multicarrier transmitter according to claim 1, wherein said second inverse wavelet transformer comprises:
a high-speed discrete sine transformer for inputting parallel data from said serial-to-parallel converter;
a second prototype filter including a polyphase filter having a real coefficient, said second prototype filter inputting output data of said high-speed discrete sine transformer;
M upsamplers for inputting output data of said second prototype filter; and
M-1 single sample delay elements for inputting output data of said upsamplers.

4. The multicarrier transmitter according to claim 1, wherein said first inverse wavelet transformer comprises:
a high-speed discrete cosine transformer for inputting parallel data from the serial-to-parallel converter;
a first prototype filter including a polyphase filter having a real coefficient, said first prototype filter inputting output data of said high-speed discrete cosine transformer;
M upsamplers for inputting output data of said first prototype filter; and
M-1 single sample delay elements for inputting output data of said upsamplers; and
said second inverse wavelet transformer comprises:
a high-speed discrete sine transformer for inputting parallel data from said serial-to-parallel converter;
a second prototype filter including a polyphase filter having a real coefficient, said second prototype filter inputting output data of said high-speed discrete sine transformer;
M upsamplers for inputting output data of said second prototype filter; and
M-1 single sample delay elements for inputting output data of said upsamplers.

5. A multicarrier receiver for performing data reception by way of digital multicarrier demodulation using a real coefficient wavelet filter bank, said multicarrier receiver comprises:
a first multiplier and a second multiplier for downconverting a received bandpass signal to a baseband signal;
a local oscillator for providing said first multiplier with a signal of a predetermined frequency;
a π/2 phase shifter for delaying the phase of said local oscillator by π/2 to generate a carrier orthogonal to said second multiplier;
a first LPF and a second LPF for removing an unwanted signal outside the band of a baseband signal output from each of said first and said second multipliers;
a first wavelet transformer for performing wavelet transform on an in-phase signal and an orthogonal signal output from each of said first LPF and said second LPF;
an equalizer for equalizing each parallel signal of an in-phase signal and an orthogonal signal output from said first wavelet transformer as a complex signal of each subcarrier;
a parallel-to-serial converter for converting a parallel signal output from said equalizer to a serial signal; and
a determination unit for determining serial data output from said parallel-to-serial converter.

6. The multicarrier receiver according to claim 5, wherein said first wavelet transformer comprises:
M-1 single sample delay elements for inputting an in-phase signal and an orthogonal signal output from said first LPF and said second LPF;
M upsamplers for inputting output data of said single sample delay elements;
a first prototype filter for inputting output data of said M upsamplers; and
a high-speed discrete cosine transformer for inputting output data of said first prototype filter.

7. A multicarrier receiver for performing data reception by way of digital multicarrier demodulation using a real coefficient wavelet filter bank, said multicarrier receiver comprises:
a multiplier for downconverting a received bandpass signal to a baseband signal;
a local oscillator for providing said multiplier with a signal of a predetermined frequency;
an LPF for removing an unwanted signal outside the band of baseband signal output from said multiplier;
a first wavelet transformer for performing a first wavelet transform on an output signal from said LPF;
a second wavelet transformer for performing Hilbert transform on the real coefficient wavelet filters of said first wavelet transformer, said second wavelet transformer including said real coefficient wavelet filters of the first wavelet transformer where Hilbert transform has been made, with the sign of said odd-numbered real coefficient wavelet filters inverted, said second wavelet transformer performing a second wavelet transform on an output signal from said LPF;
an equalizer for equalizing each parallel signal of an in-phase signal output from said first wavelet transformer and an orthogonal signal output from said second wavelet transformer as a complex signal of each subcarrier;
a parallel-to-serial converter for converting an equalized parallel signal output from said equalizer to serial data; and
a determination unit for determining serial data output from said parallel-to-serial converter.

8. The multicarrier receiver according to claim 7, wherein said first wavelet transformer comprises:
M-1 single sample delay elements for inputting an output signal of said LPF;
M upsamplers for inputting output data of said single sample delay elements;
a first prototype filter for inputting output data of said M upsamplers; and
a high-speed discrete cosine transformer for inputting output data of said first prototype filter.

9. The multicarrier receiver according to claim 7, wherein said second wavelet transformer comprises:
M-1 single sample delay elements for inputting an output signal of said LPF;
M upsamplers for inputting output data of said single sample delay elements;
a second prototype filter for inputting output data of said M upsamplers; and
a high-speed discrete sine transformer for inputting output data of said second prototype filter.

10. The multicarrier receiver according to claim 7, wherein said first wavelet transformer comprises:
M-1 single sample delay elements for inputting an output signal of said LPF;
M upsamplers for inputting output data of said single sample delay elements;
a first prototype filter for inputting output data of said M upsamplers; and
a high-speed discrete cosine transformer for inputting output data of said first prototype filter; and
said second wavelet transformer comprises:
M-1 single sample delay elements for inputting an output signal of said LPF;
M upsamplers for inputting output data of said single sample delay elements;
a second prototype filter for inputting output data of said M upsamplers; and
a high-speed discrete sine transformer for inputting output data of said second prototype filter.

11. Multicarrier communications apparatus comprising a multicarrier transmitter and a multicarrier receiver, said multicarrier communications apparatus performing data transmission by way of digital multicarrier modulation/demodulation using a real coefficient wavelet filter bank including M real coefficient wavelet filters (M being a positive integer),
said multicarrier communications transmitter comprising:
a signal point mapping unit for converting bit data to symbol data to map said symbol data on M/2 complex coordinate planes;
a serial-to-parallel converter for converting serial data as said mapped symbol data to parallel data;
a complex data decomposer for inputting said parallel data as well as decomposing complex data into a real part and an imaginary part so as to supply an in-phase component of complex information to the (2n-1) th input to said first and said second inverse wavelet transformers and supply an orthogonal component to the 2nth input (where 1≦n≦(M/2-1), a subcarrier number is 0 to M-1);
a first inverse wavelet transformer comprising said M real coefficient wavelet filters orthogonal to each other, said first inverse wavelet transformer outputting an in-phase signal of said complex data;
a second inverse wavelet transformer comprising said M real coefficient wavelet filters orthogonal to each other, said second inverse wavelet transformer outputting an orthogonal signal of said complex data; and
an SSB modulator for performing SSB modulation by using the output from said first inverse wavelet transformer as an in-phase signal of complex information and the output from said second inverse wavelet transformer as an orthogonal signal of complex information; and
wherein a detector of said multicarrier receiver comprises:
a multiplier for downconverting a received bandpass signal as a receive signal of a received bandpass signal to a baseband signal;
a local oscillator for providing said multiplier with a signal of a predetermined frequency;
an LPF for removing an unwanted signal outside the band of a baseband signal output from said multiplier;
a first wavelet transformer comprising M real coefficient wavelet filters orthogonal to each other, said first wavelet transformer inputting the output data from said LPF; and
a complex data generator for generating complex data by using the (2n-1)th output from said first wavelet transformer as an in-phase component of complex information and 2nth output as an orthogonal component (where 1≦n≦(M/2-1), a subcarrier number is 0 to M-1).

12. Multicarrier communications apparatus comprising a multicarrier transmitter and a multicarrier receiver, said multicarrier communications apparatus performing data transmission by way of digital multicarrier modulation/demodulation using a real coefficient wavelet filter bank including M real coefficient wavelet filters (M being a positive integer),
said multicarrier communications transmitter comprising:
a synchronization data generator for generating a signal as data known to said multicarrier receiver and the multicarrier transmitter according to claim 11 as a modulator for inputting said signal as know data from said synchronization data generator; and
said multicarrier receiver comprising:
the detector according to claim 11 for outputting adjacent complex subcarrier data including a subcarrier pair and a synchronization estimation circuit for estimating a symbol synchronization timing from the difference between said adjacent complex subcarrier data items.
